(19) United States
(12) Patent Application Publication
(10) Pub. No.: US 2003/0211262 A1
(43) Pub. Date: Nov. 13, 2003

(54) Duct board having two facings

(75) Inventors: John O. Ruid, Schwenksville, PA (US); Edward Krupa, Mountaintop, PA (US); Edward Hollock, Mountaintop, PA (US); Gregory Mattix, Collegeville, PA (US); Michael Hill, Mountaintop, PA (US); Richard Duncan, Royersford, PA (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(73) Assignee: CertainTeed Corporation

(21) Appl. No.: 10/141,595

(22) Filed: May 8, 2002

(51) Int. Cl. B32B 1/08

(52) U.S. Cl. 428/36.1; 428/36.91; 156/62.2

(57) ABSTRACT

A duct board material, comprises a rigid fiber glass board having an interior surface and an exterior surface. The rigid fiberglass board having a density that is less than 69.9 kilograms/meter³ (4.36 lb./foot³). An exterior facing is adhered to the exterior surface. A bonded, non-woven mat facing is adhered to the interior surface, wherein the duct board material has an elastic modulus-moment of inertia product of at least 475 pound-inch².

### FIELD OF THE INVENTION

The present invention relates to construction materials generally, and more specifically to duct board materials.

### BACKGROUND OF THE INVENTION

Glass fiberboard is used in a variety of applications. One particular use of glass fiberboard is in the construction of lightweight duct board, which is used to fabricate air ducts for heating and cooling systems. Fiber glass duct board has many advantages over metal duct materials, including its insulating characteristics, its acoustical properties, weight, and ease of handling and cutting.

Duct board is sold based on its stiffness, as measured by the product of the elastic modulus E (also referred to as Young's modulus) and the area moment of inertia I. This product is also referred to as the EI product. The EI product determines a material's resistance to bending. One common thickness for duct board is about 2.5 centimeters (1 inch). Duct board material of 2.5 centimeter thickness is commonly available with an EI of 475 pound-inch², and is also available with an EI of 800 pound-inch². Duct board material of 3.8 centimeters thickness is commonly available with an EI of 800 pound-inch². The advertised EI for any duct board product is a critical specification for which compliance is essential.

Typically, the EI specification is met by increasing the fiber board density to the point where the board is sufficiently stiff. For example, EI 800 duct board materials are commonly used in commercial applications, which require greater stiffness than residential construction.

Typical duct board materials include an outer facing, which may be a vapor barrier, such as foil-scrim-kraft (FSK).

In some duct board materials, a mat facing has been added to the interior surface of the duct board. For example, “TOUGHGARD™” duct board manufactured by Saint-Gobain CertainTeed Corp. of Valley Forge, Pa. has a non-woven mat material on its interior (air stream) surface. The mat prevents erosion of the interior duct board surface at high air flow velocities, thus increasing the maximum flow rate allowed through the duct, and improving the air quality. Although fiber glass material does not foster growth of bacteria or mold, dust and dirt from the heating, ventilation and air conditioning (HVAC) system that settles on the interior surface of the duct board may provide a source of nutrients for mirobiological growth. The interior mat facing of the “TOUGHGARD™” duct board has a biocide to obviate this problem.

An improved duct board material is desired.

### SUMMARY OF THE INVENTION

One aspect of the invention is a duct board material, comprising a rigid fiber glass board having an interior surface and an exterior surface. The rigid fiberglass board has a density that is less than 69.9 kilograms/meter³ (4.36 lb./foot³) and greater than or equal to about 54.1 kilograms/meter³ (3.38 lb./foot³). An exterior facing is adhered to the exterior surface, and a bonded, non-woven mat facing adhered to the interior surface.

Another aspect of the invention is a duct board material, comprising: a rigid fiber glass board having an interior surface and an exterior surface, the rigid fiberglass board having a mass per unit area that is less than 0.1776 grams/centimeter² (165 grams/foot²) and greater than or equal to about 0.1378 grams/centimeter² (128 grams/foot²); an exterior facing adhered to the exterior surface; and a bonded, non-woven mat facing adhered to the interior surface, wherein the duct board material has an elastic modulus-moment of inertia product of at least 475 pound-inch².

Another aspect of the invention is a duct board material, comprising: a rigid fiber glass board having an interior surface and an exterior surface. The rigid fiberglass board has a density that is less than 69.9 kilograms/meter³ (4.36 lb./foot³). An exterior facing is adhered to the exterior surface. A bonded, non-woven mat facing is adhered to the interior surface. The duct board material has an elastic modulus-moment of inertia product of at least 475 pound-inch².

Another aspect of the invention is a method for forming a duct board material, comprising the steps of (a) forming a rigid fiber glass board having an interior surface and an exterior surface, the rigid fiberglass board having a density that is less than 69.9 kilograms/meter³ (4.36 lb./foot³) and greater than or equal to about 54.1 kilograms/meter³ (3.38 lb./foot³); (b) adhering a bonded, non-woven mat facing to the interior surface; and (c) adhering an exterior facing to the exterior surface.

Still another aspect of the invention is a method for forming a duct board material, comprising the steps of: (a) forming a rigid fiber glass board having a first thickness and interior and exterior surfaces using a processing apparatus having a line speed; (b) adhering a bonded, non-woven mat facing to the interior surface of the fiber glass board material; and (c) adhering an exterior facing to the exterior surface, such that the duct board material has an elastic modulus-moment of inertia (EI) product of at least 475 pound-inch², wherein step (a) includes running the processing apparatus at a line speed approximately 1.14 to 1.27 times faster than the line speed used to fabricate a duct board having an EI product of at least 475 pound-inch² and having approximately the same first thickness without performing step (b).

Another aspect of the invention is a method for forming a duct board material, comprising the steps of: (a) forming a rigid fiber glass board having a first thickness and interior and exterior surfaces; (b) adhering a bonded, non-woven mat facing to the interior surface of the fiber glass board material, the non-woven mat having an air permeability that permits an air flow rate greater than or equal to about 1002.5 cubic feet per minute per square foot with a pressure differential of 0.5 inch of water; (c) penetrating an adhesive through the non-woven mat facing, (d) contacting the non-woven mat facing with the interior surface of the fiber glass board and a portion of a first conveyor so that the adhesive tacks the mat to the portion of the first conveyor; and (e) skidding the fiber glass board with respect to a portion of a second conveyor contacted by the exterior surface.

### BRIEF DESCRIPTION OF THE DRAWINGS

FIG. 1 is a cross sectional view of an exemplary embodiment of a duct board material according to an aspect of the present invention.

FIG. 2 is a diagram of an apparatus for forming the duct board material shown in FIG. 1.

FIG. 3 is a flow chart diagram of a process for forming the exemplary duct board material of FIG. 1.

FIG. 4 is a diagram of a portion of a duct fabricated with the duct board material of FIG. 1.

### DETAILED DESCRIPTION

The inventor has determined that non-woven facing can be applied to fiber glass duct board material of a significantly reduced density, reducing duct board weight while maintaining compliance with stiffness (EI) specifications. In other words, for a duct board material having relatively stiff facings on both the interior and exterior sides thereof, the density of the fiber glass board core can be reduced significantly from the density of an unfaced duct board material having the same minimum stiffness requirement.

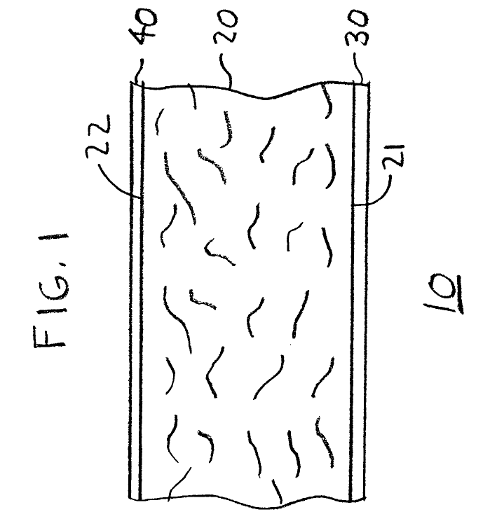

FIG. 1 is a cross sectional view of an exemplary duct board material 10. The material 10 comprises a rigid fiber glass board 20 having an interior surface 21 and an exterior surface 22. The rigid fiberglass board 20 has a density that is less than 69.9 kilograms/meter³ (4.36 lb./foot³) and greater than or equal to about 54.1 kilograms/meter³ (3.38 lb./foot³). For a 2.54 centimeter board 20 of this density range with an EI 475 rating, the mass per unit area is less than 0.1776 grams/centimeter² (165 grams/foot²) and greater than or equal to about 0.1378 grams/centimeter²(128 grams/foot²).

An exterior facing 40 is adhered to the exterior surface 22. A preferred exterior facing is Foil-Scrim-Kraft material (FSK). This material improves the strength of the duct board material and provides a vapor barrier.

A bonded, non-woven mat facing 30 is adhered to the interior surface 21. A preferred material for the non-woven mat facing 21 includes glass filaments in a resinous binder. More preferred materials include a thin, bonded, nonwoven fiber glass mat oriented in a random pattern, having sized glass fibers bonded with a resinous binder. An exemplary mat is formed of randomly oriented glass fibers about 3.2 centimeters long bonded in a process similar to that used for making paper. Thinner mat materials are preferred, because they allow better penetration of the adhesive that bonds the mat 40 to fiber board 20.

An example of a preferred material for the non-woven mat facing 30 is “DURA-GLASS®” 8440 fiber reinforced plastic mat, manufactured by Johns Manville of Toledo, Ohio. The exemplary non-woven mat facing 30 has a thickness of about 0.033 centimeter (0.013 inch). This material has a mass per unit area of about 38.8 grams/meter² (0.13 ounce/foot²).

The duct board material 10 has an elastic modulus-moment of inertia product (EI) of at least 475 pound-inch². Some preferred embodiments have an EI of about 475 pound-inch², and other preferred embodiments have an EI of at least 800 pound-inch². EI 475 materials are suitable for most residential duct applications. EI 800 materials are more commonly used for commercial construction, where higher pressure and greater air velocity is more common, but they can also be used in residential construction.

The exemplary duct board material 10 may be formed with a variety of thicknesses. A typical thickness for EI 475 duct board material 10 is about 2.54 centimeters (1.0 inch). A typical thickness for EI 800 duct board material 10 is 3.81 centimeters (1.5 inches). EI 800 duct board material is also commonly made with a thickness of about 5.1 centimeters (2 inches).

Advantageously, the exemplary duct board material 10 can be formed in the same sizes and shapes as the prior art materials, but has significantly reduced density in the fiber glass board layer 20 while satisfying the same EI specifications as the prior art materials. This reduction in density provides benefit of weight reduction and cost reduction, and improved ease of handling and cutting. Also, it is possible to produce duct board material 10 significantly faster than prior art duct board materials, using the same equipment.

In some preferred embodiments, the density of the rigid fiberglass board 20 is less than or equal to about 62.6 kilograms/meter³ (3.91 lb./foot³) and greater than or equal to about 54.1 kilograms/meter³ (3.38 lb./foot³). For a 2.54 centimeter duct board 10 of this density range, the mass per unit area of the rigid fiberglass board is less than or equal to about 0.1593 grams/centimeter² (148 grams/foot²) and greater than or equal to about 0.1378 grams/centimeter² (128 grams/foot²).

In other preferred embodiments, the density of the rigid fiberglass board is less than or equal to about 57.1 kilograms/meter³ (3.57 lb./foot³) and greater than or equal to about 54.1 kilograms/meter³ (3.38 lb./foot³). For a 2.54 centimeter duct board 10 of this density range, the mass per unit area of the rigid fiberglass board is less than or equal to about 0.1453 grams/centimeter² (135 grams/foot²) and greater than or equal to about 0.1378 grams/centimeter² (128 grams/foot²).

Some preferred embodiments include duct board material, comprising a rigid fiber glass board having an interior surface and an exterior surface, the rigid fiberglass board having a density that is less than 69.9 kilograms/meter³ (4.36 lb./foot³); an exterior facing adhered to the exterior surface; and a bonded, non-woven mat facing adhered to the interior surface, wherein the duct board material has an EI of at least 475 pound-inch². Thus, the thickness of the duct board material 10 is not limited to 2.5 centimeters, the EI may be much greater than 475 pound-inch² (and may be greater than 800 pound-inch²), and the density can be substantially less than 48 kilograms/meter³ (3 lb./foot³).

For example, faced 3.8 centimeter duct boards 10 have been fabricated with density of 3.03 lb./foot³. The EI of this duct board was 1206 (see Table 1 below). For a homogeneous (unfaced) duct board, the moment of inertia (the I component of EI) is proportional to the third power of the thickness. Thus, for duct boards having a given mass per unit area, the thicker duct board has the greater EI. When a relatively stiffer layer, such as the non-woven mat facing 30, is added to the interior face 21 (or exterior face 22), the resistance of the board 10 to deflection is greatly enhanced.

The increase in the overall “composite EI” due to the presence of the facing 30 has a location-dependent component that is approximately proportional to the square of the distance between the neutral axis (which is approximately the centroid) and the layer 30. As a result, increasing the displacement of the non-woven layer from the neutral axis by 50% (e.g., going from a 2.5 centimeter duct board to a 3.8 centimeter duct board) causes a 225% increase in the stiffening contribution caused by displacement of the non-woven mat from the neutral axis. Similarly, increasing the displacement of the non-woven layer from the neutral axis by 100% (e.g., going from a 2.5 centimeter duct board to a 5.1 centimeter duct board) causes a 400% increase in the stiffening contribution caused by displacement of the non-woven mat from the neutral axis.

Consequently, when a thicker fiber board layer 20 (e.g., 3.8 or 5.1 centimeter materials) is combined with the non-woven mat 30, the density of the fiber board layer can be even lower than the 3.0 lb./ft3 density in entry 14 of table 1. The density may be lowered to a point where the EI slightly exceeds 800 pound-inch², for an EI 800 product. Alternatively, the density could be decreased even further for EI 475 products.

A variety of other thin, stiff, porous facings may be used for interior facing layer 30. For example, the “TOUGHGARD™” duct board material mentioned above has a wet laid fiber glass non-woven mat containing an Environmental Protection Agency (EPA) registered biocide and an acrylic binder, with about 25% binder by weight. A similar facing material can be substituted for the preferred non-woven mat 30 described above. This material may have a thickness of, for example, 0.071 centimeter (0.028 inch), and a weight/square of 98 grams/m² (9.1 grams/ft²). Thicker non-woven layers may allow further reduction in the density of the fiber glass layer 20, but thinner layers have advantages in processing, as discussed further below.

Alternatively, it is contemplated that a non-woven material having a plurality of parallel fibers aligned therein may alternatively be used to increase the overall duct board stiffness in one direction.

Another aspect of the invention is a method of making a duct board material 10. One exemplary method includes forming a rigid fiber glass board 20 having a first thickness and interior and exterior surfaces 21 and 22 using a processing apparatus 100 having a line speed. A bonded, non-woven mat facing 30 is adhered to the interior surface 21 of the fiber glass board material 20. An exterior facing 40 is adhered to the exterior surface 22, such that the duct board material 10 has an elastic modulus-moment of inertia (EI) product of at least 475 pound-inch². In the exemplary method, the conveyor 120 of the processing apparatus 100 is run at a line speed approximately 1.14 to 1.27 times faster than the line speed used to fabricate a duct board having an EI product of at least 475 pound-inch 2 and having approximately the same first thickness without adhering the non-woven mat facing 30 to the interior face of the duct board.

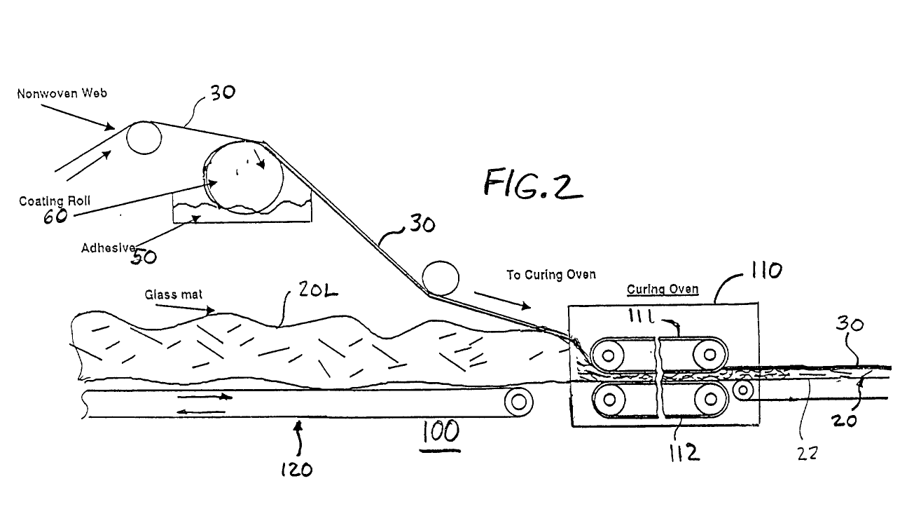

FIG. 2 shows an apparatus 100 for packing the loose fiber glass material 20L into the fiber board layer 20. The glass layer 20 is constructed from a low density fibrous glass wool. The glass fibers may be formed by a rotary process, in which glass from a furnace (not shown) enters rotary spinners (not shown), where the glass is formed into long fibers in a loose glass wool 20L, and the fibers are coated with a resin binder, such as phenol urea formaldehyde (PUFA), for example in a spraying process. The fibers are loaded onto a conveyor 120 and delivered to the curing oven 110. The fiber board layers 20 are formed by compressing the blankets of resin coated glass fibers 20L from an initial thickness of about 25 centimeters to an appropriate thickness and density and curing the resin binder. The compression is performed using two conveyor flights 111 and 112. Typically, the curing step includes blowing hot air through the blanket 20L.

Assuming that the fibers emerge from the rotary spinning apparatus (not shown) at a relatively constant mass flow rate, the mass per unit area is controlled by the line speed of oven flights 111 and 112, and the density is a function of the line speed and the spacing between flights 111 and 112 (i.e., the board thickness). For a constant board thickness, the conveyor speed of flights 111 and 112 determines density. Therefore, less dense duct board materials can be produced at a higher speed.

The inventor has also determined that the exemplary duct board material 10 can be fabricated more easily than prior art materials, because of its “tacking” ability.

The non-woven mat 30 is applied to the interior surface 21 before the loose fiber glass 20L enters the oven 110. Adhesive 50 is applied to the mat 30 as a rate sufficient to penetrate the mat 30. The penetrated adhesive 50 “tacks” the mat 30 to the top oven flight 111. The exterior side 22 of the fiber board layer 20 (bottom in FIG. 2) is made smooth, so that the exterior facing (e.g., FSK) 40 can be applied and readily adhered. The smooth surface of exterior side 22 is formed by running top flight 111 and bottom flight 112 at different speeds. The exterior surface 22 (the side to be made smooth) is “skidded” in the curing oven 110. That is, the surface 22 moves relative to the bottom flight 112. When the packed fiberglass layer 20 and mat 30 emerge from the curing oven 110, the top flight 111 peels away from the top of the mat 30.

Some mat materials are slippery and do not readily allow penetration of the adhesive 50. Such materials would tend to slide easily over the top flight 111 in the curing oven 110. The inventor has determined that a thin, porous material 30 tacks to the top flight 111 better than a thick, non-porous material. With a thin, porous mat material 30 such as the exemplary 0.033 centimeter “DURA-GLASS®” 8440 material described above, the mat readily tacks or temporarily adheres to the flight 111 that contacts mat 30. Another factor that influences the tacking is the surface tension and viscosity of the resin that tacks the mat 30 to the flight 111.

A quantitative measure that is related to the adhesive penetration is the air permeability of the facing 30. A facing material 30 having a higher air permeability is correlated with better penetration of adhesives. Also, the viscosity of the adhesive may affect the adhesive penetration. A resin that is too viscous may not penetrate sufficiently to provide the desired tacking.

The air permeability of the 8440 non-woven material described above on average is about 1002.5 cubic feet per minute per square foot at a pressure differential of 0.5 inch of water. (That is, the flow rate of air through the material with a pressure drop of 0.5 inch of water across the mat). Other materials having greater or lesser permeability may be used. A material having a permeability of 520.5 cubic feet per minute per square foot at a pressure differential of 0.5 inch of water has been demonstrated to provide acceptable results.

Although the exemplary process tacks the mat 30 to the top flight 111, for some products, it is also contemplated that the mat can be tacked to the bottom flight 112, and that the top surface can be skidded across the top flight to form a smooth top surface.

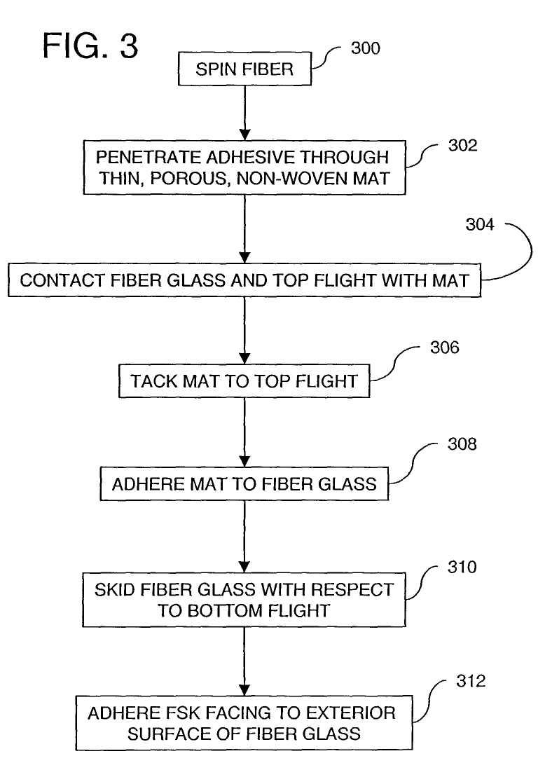

FIG. 3 is a flow chart diagram of the exemplary process.

At step 300, the rigid fiber glass board 20 is formed by spinning fiber that is fed via conveyor 120 to the curing oven 110.

At step 302, an adhesive 50 is penetrated through the thin, porous, non-woven mat facing 30.

At step 304, the non-woven mat facing is contacted with the interior surface of the fiber glass board and a portion 111 of the first conveyor.

At step 306, the adhesive 50 tacks the mat 30 to the portion 111 of the first conveyor.

At step 308, the bonded, non-woven mat facing 30 is adhered to the interior surface 21.

At step 310, the fiber glass board 20 skids with respect to a portion 112 of a second conveyor contacted by the exterior surface 22, to form a smooth exterior surface 22.

At step 312, the exterior facing 40 (e.g., FSK) is adhered to the now-smooth exterior surface 22.

### Experimental Data

Table 1 shows results from several experiments performed on a variety of exemplary duct board materials.

TABLE 1

| | | Line | | | | EI |
|---|---|---|---|---|---|---|
| | | Speed | Thickness | mass/area | density | (pound- |
| No. | Facing | (ft/min) | (cm) | (gm/ft²) | (lb/ft³) | inch²) |
| 1 | 8440 | 110 | 2.51 | 125 | 3.30 | 334 |
| 2 | None | 92 | 2.59 | 137 | 3.62 | 381 |
| 3 | None | 110 | 2.51 | 117 | 3.09 | 408 |
| 4 | None | 100 | 2.57 | 129 | 3.41 | 423 |
| 5 | 8440 | 103 | 2.39 | 130 | 3.44 | 504 |
| 6 | 8440 | 100 | 2.54 | 128 | 3.38 | 505 |
| 7 | “D” | 92 | 2.49 | 140 | 3.70 | 519 |
| 7 | 8440 | 92 | 2.49 | 137 | 3.62 | 551 |
| 8 | “C” | 92 | 2.54 | 135 | 3.57 | 560 |
| 10 | 8440 | 98 | 2.36 | 138 | 3.65 | 581 |
| 11 | 8440 | 94 | 2.41 | 144 | 3.81 | 585 |
| 12 | 8440 | 90 | 2.44 | 148 | 3.91 | 638 |
| 13 | None | 79 | 2.54 | 175 | 4.63 | 684 |
| 14 | 8440 | 78 | 3.81 | 172 | 3.03 | 1206 |
| 15 | 8440 | 68 | 3.81 | 200 | 3.52 | 1511 |
| 16 | 8440 | 54 | 3.81 | 201 | 3.54 | 1984 |
| 17 | 8440 | 48 | 3.81 | 233 | 4.11 | 2383 |

In Table 1, the 8440 facing is the “DURA-GLASS®” 8440 material referenced above. Material “C” has a finer fiber size of about 13 micrometers. Material “D” has a coarser fiber size of about 16 micrometers.

All of the entries in Table 1 exceeded the EI 475 specification, except for rows 1-4. All of the 3.8 centimeter duct board materials (entries 14-17) exceed the EI 800 specification. Entry 13 represents a 1.0 inch duct board having a density that was typical of unfaced duct boards in the prior art. The inventor has determined that a faced board 10 having a density of 4.63 pounds/ft³ exceeds the EI 475 specification value (EI=684), and that significantly lower densities may be used without compromising the stiffness. All of the entries 5-12 are 1.0 inch duct boards having significantly reduced densities and EI of more than 475 pound-inch².

Advantageously, using the same fiber spinning apparatus 100 as is used to form conventional unfaced duct board, it is possible to run the apparatus at a significantly increased line speed when fabricating the exemplary dual-faced duct board material 10. For example, the unfaced material in entry 13 of Table 1 is packed with a line speed of 24 meters/minute (79 feet/minute). In entry 12, the exemplary material 10 can be formed at a speed of 27 meters per minute (90 feet per minute) and still provide an EI of 638. This represents a 14% increase in line speed over the unfaced material. Even faster line speeds are possible. In entry 6, a line speed of 30 meters per minute (100 feet/minute) is used, and the resulting product has an EI of 505. This represents a 27% increase in line speed over the unfaced material.

An increase in line speed allows the manufacturer to produce more product in the same amount of time on a single machine. This means that in the long term, production requirements can be met with fewer spinning machines. Unneeded machines can be retired, instead of being repaired or replaced at the end of the machine life. Alternatively, the same amount of product can be made in less time on the same machines. This frees up machine time on each packing machine, so that the machines are now available to make other fiber glass products.

Preferably, the adhesive 50 is colored to match the color of the non-woven mat 30, so that penetration of the adhesive through the mat is not noticeable in the final product. For example, if a black mat is used, a black pigment may be added to adhesive 50. Alternatively, for a mat 30 that is near transparent, the adhesive may be colored to match the interior surface 21 of the fiber glass material.

Although the invention has been described in terms of exemplary embodiments, it is not limited thereto. Rather, the appended claim should be construed broadly, to include other variants and embodiments of the invention, which may be made by those skilled in the art without departing from the scope and range of equivalents of the invention.

What is claimed is:

1. A duct board material, comprising:
a rigid fiber glass board having an interior surface and an exterior surface, the rigid fiberglass board having a density that is less than 69.9 kilograms/meter³ (4.36 lb./foot³) and greater than or equal to about 54.1 kilograms/meter³ (3.38 lb./foot³);
an exterior facing adhered to the exterior surface; and
a bonded, non-woven mat facing adhered to the interior surface.

2. The duct board of claim 1, wherein the duct board material has an elastic modulus-moment of inertia product of at least 475 pound-inch².

3. The duct board of claim 2, wherein the fiber glass board has a thickness of about 2.54 centimeters (1.0 inch).

4. The duct board of claim 1, wherein the duct board material has an elastic modulus-moment of inertia product of at least 800 pound-inch².

5. The duct board material of claim 1, wherein the density of the rigid fiberglass board is less than or equal to about 62.6 kilograms/meter³ (3.91 lb./foot³) and greater than or equal to about 54.1 kilograms/meter³ (3.38 lb./foot³).

6. The duct board material of claim 1, wherein the density of the rigid fiberglass board is less than or equal to about 57.1 kilograms/meter³ (3.57 lb./foot³) and greater than or equal to about 54.1 kilograms/meter³ (3.38 lb./foot³).

7. The duct board material of claim 1, wherein the non-woven mat facing includes glass filaments in a resinous binder.

8. The duct board material of claim 7, wherein the non-woven mat facing has a mass per unit area of about 38.8 grams/meter² (0.13 ounce/foot²).

9. The duct board material of claim 1, wherein the non-woven mat facing has a thickness of about 0.033 centimeter.

10. The duct board material of claim 1, wherein the exterior facing is a vapor barrier.

11. The duct board material of claim 1, wherein the exterior facing comprises a foil-scrim-kraft layer.

12. The duct board material of claim 1, wherein
the fiber glass board has a thickness of about 2.54 centimeters (1.0 inch) and a density of less than or equal to about 62.6 kilograms/meter³ (3.91 lb./foot³) and greater than or equal to about 54.1 kilograms/meter³ (3.38 lb./foot³);
the non-woven mat facing includes glass filaments in a resinous binder, with a mass per unit area of about 38.8 grams/meter² (0.13 ounce/foot²), and a thickness of about 0.033 centimeter; and
the exterior facing comprises a foil-scrim-kraft layer.

13. The duct board material of claim 12, wherein the density of the rigid fiberglass board is less than or equal to about 57.1 kilograms/meter³ (3.57 lb./foot³) and greater than or equal to about 54.1 kilograms/meter³ (3.38 lb./foot³).

14. A duct board material, comprising:
a rigid fiber glass board having an interior surface and an exterior surface, the rigid fiberglass board having a mass per unit area that is less than 0.1776 grams/centimeter² (165 grams/foot²);
an exterior facing adhered to the exterior surface; and
a bonded, non-woven mat facing adhered to the interior surface, wherein the duct board material has an elastic modulus-moment of inertia product of at least 475 pound-inch².

15. The duct board of claim 14, wherein the fiber glass board has a thickness of about 2.54 centimeters (1.0 inch) and the mass per unit area of the rigid fiberglass board is greater than or equal to about 0.1378 grams/centimeter² (128 grams/foot²).

16. The duct board material of claim 14, wherein the mass per unit area of the rigid fiberglass board is less than or equal to about 0.1593 grams/centimeter² (148 grams/foot²).

17. The duct board material of claim 14, wherein the mass per unit area of the rigid fiberglass board is less than or equal to about 0.1453 grams/centimeter² (135 grams/foot²).

18 A duct board material, comprising:
a rigid fiber glass board having an interior surface and an exterior surface, the rigid fiberglass board having a density that is less than 69.9 kilograms/meter³ (4.36 lb./foot³);
an exterior facing adhered to the exterior surface; and
a bonded, non-woven mat facing adhered to the interior surface, wherein the duct board material has an elastic modulus-moment of inertia product of at least 475 pound-inch².

19. The duct board material of claim 18, wherein the density of the rigid fiberglass board is less than or equal to about 62.6 kilograms/meter³ (3.91 lb./foot³) and greater than or equal to about 54.1 kilograms/meter³ (3.38 lb./foot³).

20. The duct board material of claim 18, wherein the density of the rigid fiberglass board is less than or equal to about 57.1 kilograms/meter³ (3.57 lb./foot³) and greater than or equal to about 54.1 kilograms/meter³ (3.38 lb./foot³).

21. The duct board of claim 18, wherein the duct board material has an elastic modulus-moment of inertia product of at least 800 pound-inch².

22. An air duct, comprising:
a duct board having a plurality of sections folded to form a duct, the duct board comprising:
a rigid fiber glass board having an interior surface and an exterior surface, the rigid fiberglass board having a density that is less than 69.9 kilograms/meter³ (4.36 lb./foot³) and greater than or equal to about 54.1 kilograms/meter³ (3.38 lb./foot³);
an exterior facing adhered to the exterior surface; and
a bonded, non-woven mat facing adhered to the interior surface, wherein the duct board material has an elastic modulus-moment of inertia product of at least 475 pound-inch².

23. A method for forming a duct board material, comprising the steps of:
(a) forming a rigid fiber glass board having an interior surface and an exterior surface, the rigid fiberglass board having a density that is less than 69.9 kilograms/meter³ (4.36 lb./foot³) and greater than or equal to about 54.1 kilograms/meter³ (3.38 lb./foot³);
(b) adhering a bonded, non-woven mat facing to the interior surface; and
(c) adhering an exterior facing to the exterior surface.

24. The method of claim 23, wherein step (b) includes:
penetrating an adhesive through the non-woven mat facing, and
contacting the non-woven mat facing with the interior surface of the fiber glass board and a portion of a first conveyor so that the adhesive tacks the mat to the portion of the first conveyor; and
the method further comprises skidding the fiber glass board with respect to a portion of a second conveyor contacted by the exterior surface before step (c).

25. The method of claim 24, wherein the non-woven mat facing is formed from glass filaments in a resinous binder, and the mat has a thickness of about 0.033 centimeter (0.013 inch).

26. A method for forming a duct board material, comprising the steps of:
(a) forming a rigid fiber glass board having a first thickness and interior and exterior surfaces using a processing apparatus having a line speed;
(b) adhering a bonded, non-woven mat facing to the interior surface of the fiber glass board material; and
(c) adhering an exterior facing to the exterior surface, such that the duct board material has an elastic modulus-moment of inertia (EI) product of at least 475 pound-inch²,
wherein step (a) includes running the processing apparatus at a line speed approximately 1.14 to 1.27 times faster than the line speed used to fabricate a duct board having an EI product of at least 475 pound-inch² and having approximately the same first thickness without performing step (b).

27. The method of claim 26, wherein:
the fiber glass board has a thickness of about 2.54 centimeters (1 inch);
the line speed used to fabricate the duct board material is at least 27 meters per minute (90 feet per minute).

28. The method of claim 26, wherein:
the fiber glass board has a thickness of about 2.54 centimeters (1 inch);
the line speed used to fabricate the duct board material is at least 30 meters per minute (100 feet per minute).

29. The method of claim 26, wherein the non-woven mat facing is formed from glass filaments in a resinous binder, and the mat has a thickness of about 0.033 centimeter (0.013 inch).

30. The method of claim 26, wherein step (b) includes:
penetrating an adhesive through the non-woven mat facing, and
contacting the non-woven mat facing with the interior surface of the fiber glass board and a portion of a first conveyor so that the adhesive tacks the mat to the portion of the first conveyor; and
the method further comprises skidding the fiber glass board with respect to a portion of a second conveyor contacted by the exterior surface before step (c).

31. The method of claim 30, wherein the non-woven mat has an air permeability that permits an air flow rate greater than or equal to about 520.5 cubic feet per minute per square foot with a pressure differential of 0.5 inch of water.

32. The method of claim 30, wherein the non-woven mat has an air permeability that permits an air flow rate greater than or equal to about 1002.5 cubic feet per minute per square foot with a pressure differential of 0.5 inch of water.

32. A method for forming a duct board material, comprising the steps of:
(a) forming a rigid fiber glass board having a first thickness and interior and exterior surfaces;
(b) adhering a bonded, non-woven mat facing to the interior surface of the fiber glass board material, the non-woven mat having an air permeability that permits an air flow rate greater than or equal to about 1002.5 cubic feet per minute per square foot with a pressure differential of 0.5 inch of water;
(c) penetrating an adhesive through the non-woven mat facing,
(d) contacting the non-woven mat facing with the interior surface of the fiber glass board and a portion of a first conveyor so that the adhesive tacks the mat to the portion of the first conveyor; and
(e) skidding the fiber glass board with respect to a portion of a second conveyor contacted by the exterior surface.
